(19) United States
(12) Patent Application Publication
(10) Pub. No.: US 2018/0096072 A1
(43) Pub. Date: Apr. 5, 2018

(54) PERSONALIZATION OF A VIRTUAL ASSISTANT

(71) Applicant: Google Inc., Mountain View, CA (US)

(72) Inventors: Ruijie He, Boston, MA (US); Wan Fen Nicole Quah, Mountain View, CA (US); Bryan Horling, Belmont, MA (US); Maryam Garrett, Cambridge, MA (US)

(21) Appl. No.: 15/365,135

(22) Filed: Nov. 30, 2016

Related U.S. Application Data
(60) Provisional application No. 62/403,602, filed on Oct. 3, 2016.

(51) Int. Cl. G06F 17/30; G06F 17/27; G06F 3/0481

(52) U.S. Cl. CPC G06F 17/30867; G06F 3/0481; G06F 17/2705

(57) ABSTRACT

An assistant executing at one or more processors is described that receives an indication of an initial user input that is indicative of an initial conversation between a user and the assistant. The assistant parses the initial user input for an initial command and identifies an initial reference to personal information not previously associated with a value that is specific to the user. The assistant generates a personal record associated with the user that stores an indication of the personal information. The assistant receives an indication of a subsequent user input that is indicative of a subsequent conversation between the user and the assistant. The assistant parses the subsequent user input for a subsequent command and identifies a subsequent reference to the personal information stored at the personal record. The assistant executes the subsequent command based on the personal information stored at the personal record.

This application claims the benefit of U.S. Provisional Application No. 62/403,602, filed Oct. 3, 2016, the entire contents of which is incorporated by reference herein.

### BACKGROUND

Some computing platforms may provide a user interface from which a user can chat, speak, or otherwise communicate with a virtual, computational assistant (e.g., also referred to as “an intelligent assistant” or simply as an “assistant”) to cause the assistant to output useful information, respond to a user's needs, or otherwise perform certain operations to help the user complete a variety of real-world or virtual tasks. An assistant may function more naturally when the assistant can quickly ascertain a user instruction, and immediately begin taking action to complete a task. Unfortunately, some assistants may need to repeatedly search amongst multiple (internal and external) sources of information, or elicit additional user input, each time the assistant needs a specific piece of information to complete a task. Having to frequently execute complicated and time consuming searches, or elicit additional user input, may cause the assistant to execute slowly and induce pauses or hesitations in a conversation with the assistant, making the assistant seem awkward and less desirable to the user.

### SUMMARY

In one example, the disclosure is directed to a method that includes receiving, by an assistant executing at one or more processors, an indication of an initial user input that is indicative of an initial conversation between a user of the computing device and the assistant; parsing the initial user input for an initial command; identifying, by the assistant, based on the initial user input, an initial reference to personal information not previously associated with a value that is specific to the user; and generating, by the assistant, a personal record associated with the user that stores an indication of the personal information. The method further includes receiving, by the assistant, an indication of a subsequent user input that is indicative of a subsequent conversation between the user and the assistant; parsing the subsequent user input for a subsequent command, identifying, by the assistant, based on the subsequent user input, a subsequent reference to the personal information; and executing, by the assistant, based on the indication of the personal record associated with the user that stores the indication of the personal information, the subsequent command.

In another example, the disclosure is directed to a system that includes one or more processors and a memory comprising instructions that when executed cause the one or more processors to receive an indication of an initial user input that is indicative of an initial conversation between a user of a computing device and an assistant; parse the initial user input for an initial command; identify, based on the initial user input, an initial reference to personal information not previously associated with a value that is specific to the user; and generate a personal record associated with the user that stores an indication of the personal information. The instructions, when executed, further cause the one or more processors to receive an indication of a subsequent user input that is indicative of a subsequent conversation between the user and the assistant; parsing the subsequent user input for a subsequent command, identify, based on the subsequent user input, a subsequent reference to the personal information; and execute, based on the indication of the personal record associated with the user that stores the indication of the personal information, the subsequent command.

In another example, the disclosure is directed to a computer-readable storage medium including instructions that when executed cause one or more processors of a system to receive an indication of an initial user input that is indicative of an initial conversation between a user of a computing device and an assistant; parse the initial user input for an initial command; identify, based on the initial user input, an initial reference to personal information not previously associated with a value that is specific to the user; and generate a personal record associated with the user that stores an indication of the personal information. The instructions, when executed, further cause the one or more processors to receive an indication of a subsequent user input that is indicative of a subsequent conversation between the user and the assistant; parse the subsequent user input for a subsequent command; identify, based on the subsequent user input, a subsequent reference to the personal information; and execute, based on the indication of the personal record associated with the user that stores the indication of the personal information, the subsequent command.

In another example, the disclosure is directed to a system comprising means for receiving an indication of an initial user input that is indicative of an initial conversation between a user of the computing device and an assistant; means for parsing the initial user input for an initial command; means for identifying, based on the initial user input, an initial reference to personal information not previously associated with a value that is specific to the user; and means for generating a personal record associated with the user that stores an indication of the personal information. The system further includes means for receiving an indication of a subsequent user input that is indicative of a subsequent conversation between the user and the assistant; while parsing the subsequent user input for a subsequent command, means for identifying, based on the subsequent user input, a subsequent reference to the personal information; and means for executing, based on the indication of the personal record associated with the user that stores the indication of the personal information, the subsequent command.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system that executes an example virtual assistant, in accordance with one or more aspects of the present disclosure.

FIG. 2 is a block diagram illustrating an example computing device that is configured to execute an example virtual assistant, in accordance with one or more aspects of the present disclosure.

FIG. 3 is a flowchart illustrating example operations performed by one or more processors executing an example virtual assistant, in accordance with one or more aspects of the present disclosure.

FIG. 4 is a block diagram illustrating an example computing device that is configured to execute an example virtual assistant, in accordance with one or more aspects of the present disclosure.

### DETAILED DESCRIPTION

In general, techniques of this disclosure may enable a virtual, computational assistant (e.g., also referred to as “an intelligent assistant” or simply as an “assistant”) to automatically obtain personal information associated with a user of a computing device during ongoing conversations between the user and the assistant. The assistant may automatically maintain personal records of the information the assistant obtains during regular conversations with the user. The assistant may store the information as a personal record in a structured and semantic fashion. Maintaining personal records may enable the assistant to later quickly access the personal information, without executing a search or eliciting further user input, to complete a real-world task, a virtual task, or otherwise respond to a user's immediate or future need.

The assistant may only retain personal records associated with a user after first receiving explicit permission from the user to do so. Thus, the user may have complete control over how the assistant collects and uses information about the user. Before the assistant stores personal information either as a personal record or in some other form, the assistant may encrypt or otherwise treat the information to remove the actual identity of the user, so that personally-identifiable information is removed from the personal records of the user. The assistant may provide a way for the user to modify or remove information from the personal records. In this way, the user may have complete control over the information being retained by the assistant.

Each entry in the personal records may be associated with a predefined schema that can be quickly parsed by the assistant when the assistant needs more information (e.g., than what may be provided from a user input) to better understand user needs and help the user to complete a task. Once personal information has been recorded as a personal record or value that is specific to the user, the assistant can use that information (e.g., use that specific value) to complete a task. If there is no ongoing task, the assistant may provide the user with examples of how the assistant may use the information to help the user in the future. The user may later ask the assistant to forget or modify this information (e.g., by changing the value specific to the user).

For instance, after the assistant receives user input indicating that the user consents to providing the assistant with personal information about the user, the assistant may receive an indication of an input (e.g., voice, text, email, etc., but for simplicity referred to herein as a voice input) from the user that instructs the assistant to perform a task. If the assistant deems that voice input indicates the task is of a more personal nature (e.g., telephone “Mom”) or a user-specified preference for personal information (e.g., “call MY dentist”) as opposed to being of a more public nature (e.g., “tell me who won the college football championship last night” or “find me A dentist nearby”), the assistant may parse, search, or otherwise analyze the personal records previously stored to quickly ascertain the information needed (e.g., information indicative of a person having a maternal relationship with the user) to complete the task specified by the voice input. If the assistant is unsuccessful in obtaining the necessary information from the personal records of the user, the assistant may automatically engage in a conversation with the user (e.g., requesting additional voice or text input) until the assistant obtains the missing information. Upon obtaining the missing information, the assistant may add the missing information to the personal records so that the missing information is quickly and readily available when needed for responding to a future user input.

In this way, during everyday conversations with the user, the example assistant may automatically glean personal information from user input that the example assistant infers will likely be needed to complete future tasks. The term “conversation” as used throughout this specification refers to regular interactions between a user of a computing device and an assistant executing at or accessible from the computing device as opposed to interactions that might occur during initial set up, installation, first time use, etc. In other words, the conversation occurs during everyday use of the assistant, by the user, as the user is performing a task other than setting up the assistant. Conversation as used herein does not refer to a user answering questions as part setting up an app or providing in preset fields of a user interface.

The example assistant may retain the personal information as personal records to enable the example assistant to quickly retrieve the information while in the midst of a conversation with a user. Therefore, while other assistants may need to repeatedly search amongst multiple (internal or external) information sources, or elicit additional user input, each time these other assistants are tasked to respond to a specific user need, the example assistant may be able to more quickly ascertain what a user needs by relying on the personal records to recall personal information about a user, and what may seem to a user to occur immediately, without having to search multiple information sources, begin taking action to satisfy a need. The example assistant may therefore support a computing device's and/or system's ability to complete tasks more quickly and/or respond to user input faster than other assistants. By executing faster, the example assistant may minimize pauses or hesitations in conversations with the user which may make conversing with the assistant seem natural, less awkward, and more desirable to the user.

Throughout the disclosure, examples are described where a computing device and/or a computing system analyzes information (e.g., context, locations, communications, contacts, chat conversations, voice conversations, etc.) associated with a computing device and a user of a computing device, only if the computing device receives permission from the user of the computing device to analyze the information. For example, in situations discussed below, before an assistant executing at a computing device or computing system can collect or may make use of information associated with a user, the user may be provided with an opportunity to provide input to control whether the assistant (or other programs or features of the computing device and/or computing system) can collect and make use of user information or to dictate whether and/or how to computing devices and/or computing systems may receive content that may be relevant to the user. In addition, certain data may be encrypted and/or treated in one or more ways before it is stored or used by the assistant or underlying computing device and/or computing system, so that personally-identifiable information is removed. For example, a user's identity may be treated so that no personally identifiable information can be determined about the user, or a user's geographic location may be generalized where location information is obtained (such as to a city, ZIP code, or state as opposed to a coordinate location or physical address), so that a particular location of a user cannot be determined. Thus, the user may have control over how information is collected about the user and used by the assistant and the underlying computing device and computing system that executes the assistant.

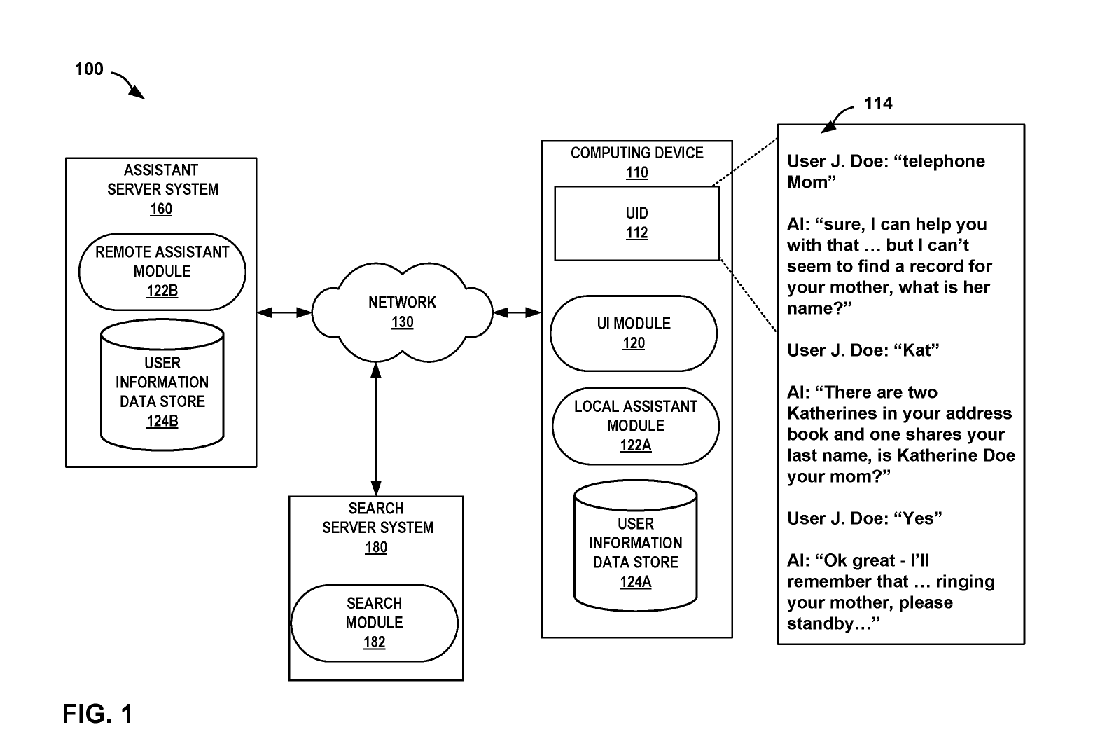

FIG. 1 is a conceptual diagram illustrating an example system that executes an example virtual assistant, in accordance with one or more aspects of the present disclosure. System 100 of FIG. 1 includes assistant server system 160 in communication, via network 130, with search server system 180 and computing device 110. Although system 100 is shown as being distributed amongst assistant server system 160, search server system 180, and computing device 110, in other examples, the features and techniques attributed to system 100 may be performed internally, by local components of computing device 110. Similarly, assistant server system 160 may include certain components and perform various techniques that are otherwise attributed in the below description to search server system 180 and/or computing device 110.

Network 130 represents any public or private communications network, for instance, cellular, Wi-Fi, and/or other types of networks, for transmitting data between computing systems, servers, and computing devices. Assistant server system 160 may exchange data, via network 130, with computing device 110 to provide a virtual assistant service that is accessible to computing device 110 when computing device 110 is connected to network 130. Assistant server system 160 may exchange data, via network 130, with search server system 180 to access a search service provided by search server system 180. Computing device 110 may exchange data, via network 130, with search server system 180 to access the search service provided by search server system 180.

Network 130 may include one or more network hubs, network switches, network routers, or any other network equipment, that are operatively inter-coupled thereby providing for the exchange of information between server systems 160 and 180 and computing device 110. Computing device 110, assistant server system 160, and search server system 180 may transmit and receive data across network 130 using any suitable communication techniques. Computing device 110, assistant server system 160, and search server system 180 may each be operatively coupled to network 130 using respective network links. The links coupling computing device 110, assistant server system 160, and search server system 180 to network 130 may be Ethernet or other types of network connections and such connections may be wireless and/or wired connections.

Assistant server system 160 and search server system 180 represent any suitable remote computing systems, such as one or more desktop computers, laptop computers, mainframes, servers, cloud computing systems, etc. capable of sending and receiving information both to and from a network, such as network 130. Assistant server system 160 hosts (or at least provides access to) a virtual assistant service. Search server system 180 hosts (or at least provides access to) a search service. In some examples, assistant server system 160 and search server system 180 represent cloud computing systems that provide access to their respective services via a cloud.

Computing device 110 represents an individual mobile or non-mobile computing device. Examples of computing device 110 include a mobile phone, a tablet computer, a laptop computer, a desktop computer, a server, a mainframe, a set-top box, a television, a wearable device (e.g., a computerized watch, computerized eyewear, computerized gloves, etc.), a home automation device or system (e.g., an intelligent thermostat or home assistant device), a personal digital assistants (PDA), a gaming system, a media player, an e-book reader, a mobile television platform, an automobile navigation or infotainment system, or any other type of mobile, non-mobile, wearable, and non-wearable computing device configured to execute or access a virtual assistant and receive information via a network, such as network 130.

Assistant server system 160 and/or search server system 180 may communicate with computing device 110 via network 130 to give computing device 110 access the virtual assistant service provided by assistant server system 160 and/or to provide computing device 110 access to the search service provided by search server system 180. In the course of providing virtual assistant services, assistant server system 160 may communicate with search server system 180 via network 130 to obtain search results for providing a user of the virtual assistant service information to complete a task.

In the example of FIG. 1, assistant server system 160 includes remote assistant module 122B and user information data store 124B. Remote assistant module 122B may maintain user information data store 124B as part of a virtual assistant service that assistant server system 160 provides via network 130 (e.g., to computing device 110). Computing device 110 includes user interface device (UID) 112, user interface (UI) module 120, local assistant module 122A, and user information data store 124A. Local assistant module 122A may maintain user information data store 124A as part of a virtual assistant service that executes locally at computing device 110. Remote assistant module 122B and local assistant module 122A may be referred to collectively as assistant modules 122A and 122B. Local data store 124A and remote data store 124B may be referred to collectively as data stores 124A and 124B.

Modules 120, 122A, 122B, and 182 may perform operations described using software, hardware, firmware, or a mixture of hardware, software, and firmware residing in and/or executing at one of computing device 110, assistant server system 160, or search server system 180. Computing device 110, assistant server system 160, and search server system 180 may execute modules 120, 122A, 122B, and 182 with multiple processors or multiple devices. Computing device 110, assistant server system 160, and search server system 180 may execute modules 120, 122A, 122B, and 182 as virtual machines executing on underlying hardware. Modules 120, 122A, 122B, and 182 may execute as one or more services of an operating system or computing platform. Modules 120, 122A, 122B, and 182 may execute as one or more executable programs at an application layer of a computing platform.

UID 112 of computing device 110 may function as an input and/or output device for computing device 110. UID 112 may be implemented using various technologies. For instance, UID 112 may function as an input device using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology.

UID 112 may function as an input device using microphone technologies, infrared sensor technologies, or other input device technology for use in receiving user input. For example, UID 112 may detect, using built-in microphone technology, voice input that UI module 120 and/or local assistant module 122A processes for completing a task. As another example, UID 112 may include a presence-sensitive display that may receive tactile input from a user of computing device 110. UID 112 may receive indications of tactile input by detecting one or more gestures from a user (e.g., the user touching or pointing to one or more locations of UID 112 with a finger or a stylus pen).

UID 112 may function as output (e.g., display) device and present output to a user. UID 112 may function as an output device using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110. UID 112 may function as output device using speaker technologies, haptic feedback technologies, or other output device technology for use in outputting information to a user. UID 112 may present a user interface (e.g., user interface 114) related to a virtual assistant provided by local assistant module 122A and/or remote assistant module 122B. UID 112 may present a user interface related to other features of computing platforms, operating systems, applications, and/or services executing at and/or accessible from computing device 110 (e.g., e-mail, chat, online services, telephone, gaming, etc.).

UI module 120 may manage user interactions with UID 112 and other components of computing device 110 including interacting with assistant server system 160 so as to provide assistant services via UID 112. UI module 120 may cause UID 112 to output a user interface, such as user interface 114 (or other example user interfaces), as a user of computing device 110 views output and/or provides input at UID 112. UI module 120 and UID 112 may receive one or more indications of input (e.g., voice input, gesture input, etc.) from a user as the user interacts with the user interface, at different times and when the user and computing device 110 are at different locations. UI module 120 and UID 112 may interpret inputs detected at UID 112 and may relay information about the inputs detected at UID 112 to local assistant module 122A and/or one or more other associated platforms, operating systems, applications, and/or services executing at computing device 110, for example, to cause computing device 110 to perform functions.

UI module 120 may receive information and instructions from one or more associated platforms, operating systems, applications, and/or services executing at computing device 110 and/or one or more remote computing systems, such as server systems 160 and 180. In addition, UI module 120 may act as an intermediary between the one or more associated platforms, operating systems, applications, and/or services executing at computing device 110, and various output devices of computing device 110 (e.g., speakers, LED indicators, audio or haptic output device, etc.) to produce output (e.g., a graphic, a flash of light, a sound, a haptic response, etc.) with computing device 110.

Search module 182 may execute a search for information determined to be relevant to a search query that search module 182 automatically generates (e.g., based on contextual information associated with computing device 110) or that search module 182 receives from assistant server system 160 or computing device 110 (e.g., as part of a task that a virtual assistant is completing on behalf of a user of computing device 110). Search module 182 may conduct an Internet search based on a search query to identify information (e.g., weather or traffic conditions, news, stock prices, sports scores, user schedules, transportation schedules, retail prices, etc.) related to the search query from amongst from a variety of information sources (e.g., either stored locally or remote to search server system 180). After executing a search, search module 182 may output the information returned from the search (e.g., the search results) to assistant server system 160 or computing device 110.

In the example of FIG. 1, user interface 114 is a graphical user interface associated with a virtual assistant service accessed by computing device 110 (e.g., provided by local assistant module 122A and/or remote assistant module 122B of assistant server system 160). User interface 114 may in some examples be an audible user interface. As shown in FIG. 1, user interface 114 shows text of a conversation between a user of computing device 110 and a virtual assistant executing at or accessible to computing device 110. User interface 114 may include virtual assistant information in various forms such as audible sound, vibrations, text, graphics, content cards, images, etc. UI module 120 may cause UID 112 to output user interface 114 based on data UI module 120 receives via network 130 from assistant server system 160. UI module 120 may receive information (e.g., audio data, text data, image data, etc.) for presenting user interface 114 as input from assistant server system 160 and/or local assistant module 122A, along with instructions from assistant server system 160 and/or local assistant module 122A for presenting the information within user interface 114 at UID 112.

Local assistant module 122A of computing device 110 and remote assistant module 122B of assistant server system 160 may each perform similar functions described herein for automatically executing an assistant that is configured to obtain personal information associated with a user of a computing device during ongoing conversations between the user and the assistant. Remote assistant module 122B and user information data store 124B represent server-side or cloud implementations of an example virtual assistant whereas local assistant module 122A and user information data store 124A represent a client-side or local implementation of the example virtual assistant.

Modules 122A and 122B may each include respective software agents configured to execute as intelligent personal assistants that can perform tasks or services for an individual, such as a user of computing device 110. Modules 122A and 122B may perform these tasks or services based on user input (e.g., detected at UID 112), location awareness (e.g., based on context), and/or the ability to access other information (e.g., weather or traffic conditions, news, stock prices, sports scores, user schedules, transportation schedules, retail prices, etc.) from a variety of information sources (e.g., either stored locally at computing device 110, assistant server system 160, or obtained via the search service provided by search server system 180). Modules 122A and 122B may perform artificial intelligence and/or machine learning techniques to automatically identify and complete one or more tasks on behalf of a user.

The respective assistant provided by remote assistant module 122B and local assistant module 122A may, in the course of executing operations to support conversations with a user of computing device 110, automatically create, generate, or otherwise maintain personal records of information obtained during the conversations and store the personal records as values that are specific to the user, in a structured and semantic fashion as user information data store 124B and user information data store 124A, respectively. Data stores 124B and 124A may enable, respectively, the respective assistant executed by remote assistant module 122B and local assistant module 122A to quickly access the personal information (e.g., the values that are specific to the user) to complete a real-world task, a virtual task, or otherwise respond to immediate or future need of the user of computing device 110. For ease of description, the techniques of this disclosure are described primarily from the perspective of being performed by local assistant module 122A.

Assistant modules 122A and 122B may maintain user information data stores 124A and 124B as part of a virtual assistant service that assistant modules 122A and 122B together, or separately, provide to computing device 110. The assistant(s) provided by assistant modules 122A and 122B may, in the course of executing operations to support a conversation with a user of computing device 110, maintain personal records of the information being automatically culled from the conversations and store the personal records in a structured and semantic fashion as user information data store 124A and 124B. Data stores 124A and 124B may enable the assistant executed by assistant modules 122A and 122B to quickly access the personal information to complete a real-world task, a virtual task, or otherwise respond to immediate and/or future needs of the user of computing device 110.

Assistant modules 122A and 122B may only retain personal records associated with a user of computing device 110 after first receiving explicit permission from the user to do-so. Thus, the user may have complete control over how the assistant collects and uses information about the user. For example, prior to retaining personal records associated with the user of computing device 110, assistant modules 122A and 122B may cause UI module 120 to present a user interface via UID 112 that requests a user to select a box, click a button, state a voice input, or otherwise provide a specific input to the user interface that is interpreted by assistant modules 122A and 122B as unambiguous, affirmative consent for assistant modules 122A and 122B to collect and make use of the user's personal information.

Assistant modules 122A and 122B may encrypt or otherwise treat the information being maintained as personal records to remove the actual identity of the user before storing the personal information at data stores 124A and 124B. For example, the information may be treated by assistant modules 122A and 122B so that any personally-identifiable information is removed from the personal records of the user when stored at data stores 124A and 124B.

Assistant modules 122A and 122B may cause UI module 120 to present a user interface via UID 112 from which the user of computing device 110, may modify or remove information from the personal records stored at data stores 124A and 124B. For example, the user interface may provide areas at which the user of computing device 110 can provide input to communicate to assistant modules 122A and 122B a command to modify or remove specific pieces of personal information. In this way, the user of computing device 110 may have complete control over the information being retained by assistant modules 122A and 122B at data stores 124A and 124B.

Each entry in the personal records stored by data stores 124A and 124B may be associated with a predefined schema that can be quickly traversed or parsed by assistant modules 122A and 122B to find the information assistant modules 122A and 122B need at a current time for understanding user needs and for helping the user to complete a task. Once personal information has been recorded as one or more values that are specific to a user, assistant modules 122A and 122B can quickly use information stored at data stores 124A and 124B to complete a task. If there is no ongoing task, assistant modules 122A and 122B may provide the user (e.g., via user interface 114) with examples of how the assistant may use the information to help the user in the future. The user may later provide input at UID 112 to command assistant modules 122A and 122B to forget or modify this information.

The values stored by data stores 124A and 124B may be textual values (e.g., names of persons, names of places, other textual descriptors of entities), numerical values (e.g., age, height, weight, other physiological data, other numerical information associated with entities), or pointers to values specific to a user (e.g., a location in memory to an entity in a knowledge graph of a user, a location in memory to a contact in an address book, etc.). In other words, a value specific to a user may take many forms and be specific to a field of a personal record that is defined by the recording schema. The value may indicate the actual information that is specific to the user or may be a reference to a location from which the information specific to the user can be retrieved.

After assistant modules 122A and 122B receives an indication of user input detected by UID 112 that indicates the user consents to providing assistant modules 122A and 122B with personal information about the user, assistant modules 122A and 122B may receive an indication of user input (e.g., a natural language voice or text input) from UI module 120 that includes instructions for causing assistant modules 122A and 122B to do something. If the user input indicates it is of a more personal request (e.g., telephone “Mom”) as opposed to a more public request (e.g., “tell me who won the college football championship last night”), assistant modules 122A and 122B may parse or traverse the personal records previously stored at data stores 124A and 124B to quickly ascertain the information needed to complete a task specified by the user input. Conversely, if the user input indicates it is of a more public request as opposed to a more private request, assistant modules 122A and 122B may send the user input or a portion thereof (e.g., as an indication of a search query) to search server system 180 to cause search module 182 to execute a search for information related to the user input.

A variety of methods may be employed to determine whether the user input suggests personal data versus public data. For example, they type of content or entities referred to in the user input, such as familial terms, personal pronouns can be signals of an interest in personal data. Matches to stored personal data, such as person names, locations, and this like can also signal a user's interest in personal data. Conversely, an examination of the content of the input can suggest a bias away from personal data, such as reference to public entities (e.g., sports teams, public points of interest, celebrities, etc.) Other techniques for anticipating a user's interest in personal versus public information are also contemplated, including utilizing user history, process of elimination, machine learning methods, and so on.

In some examples, assistant modules 122A and 122B may determine whether a user input is a public request or a personal request, prior to creating a personal record. In other words, assistant modules 122A and 122B may preempt identifying an initial reference to personal information by first determining whether the user input is a personal request.

For example, assistant modules 122A and 122B may determine that user input is a public request in response to identifying one or more public entities or public content from the user input (e.g., sports team, celebrity name, restaurant, geographic location, general idea or topic, etc.). Conversely, assistant modules 122A and 122B may determine that a user input is a private request in response to identifying one or more private entities or private content from the initial user input (e.g., name of a non-celebrity or person in a contact list, personal pronoun, familial terms, a specific name or synonym for a field in a personal record, etc.).

Responsive to determining that the initial user input is a personal request, assistant modules 122A and 122B may parse the personal record associated with the user for the personal information. Conversely, responsive to determining that the initial user input is a public request, assistant modules 122A and 122B may cause search module 182 to execute a public search for information to execute the command.

Responsive to determining that the initial user input is a personal request, assistant modules 122A and 122B may parse the personal record associated with the user for the personal information and identify an initial reference to personal information in response to determining that the personal record comprises a null or zero value in a field associated with the personal information. In other words, after determining a user request is personal and not public in nature, assistant modules 122A and 122B may search the personal records of the user for information needed to satisfy the request and in response to identifying no specific user value associated with the needed information, assistant modules 122A and 122B may recognize the request and a first instance or initial reference to the personal information.

In the case where the user input includes references to more personal information and therefore is of a more private request, if the assistant is unsuccessful in obtaining the necessary information from the personal records of the user stored at data stores 124A and 124B, assistant modules 122A and 122B may automatically cause UI module 120 to output text or audio via UID 112 to converse with the user (e.g., to request additional voice or text input) until assistant modules 122A and 122B obtain the missing information from additional user input. Upon obtaining the missing information from additional user input, assistant modules 122A and 122B may add the missing information to the personal records stored at data stores 124A and 124B so that the information can quickly and readily be obtained when responding to a future user input.

In operation, local assistant module 122A may receive an indication of user input detected by UI module 120 at UID 112 indicating that the user consents to local assistant module 122A making use of and storing personal information about the user. In response to receiving the indication of consent from the user, local assistant module 122A may receive, from UI module 120, an indication of a voice input from the user that instructs local assistant module 122A to cause computing device 110 to execute operations to perform a task to “telephone Mom”. For example, user interface 114 shows a transcription of the voice input being recognized by local assistant module 122A and in response, being output for display or as audio via UID 112.

Local assistant module 122A may parse, traverse, or otherwise analyze the voice input (e.g., using natural language processing or performing other voice recognition techniques) to recognize the word “Mom” from the voice input. Local assistant module 122A may determine that “Mom” may specify a generic or descriptive identity of a person that is both personal to the user (e.g., from the nature of the word mom) and worth retaining for executing future commands. In response to failing to identify any previously created personal records with fields that refer to “Mom”, mom, mother, or some synonym thereof, local assistant module 122A may create a personal record at data store 124A for storing the information about a personal contact named “Mom”, for future access. Local assistant module 122A may create the record at data store 124A according to a predefined schema for storing information associated with a personal contact. That is, the personal record may include one or more generic “name fields” that start out as being unpopulated or a value that is not specific to the user (e.g., having zeroed or null values or generic placeholders). The personal record may include a “relationship field” that specifies the relationship between that person and the user. Local assistant module 122A may automatically populate the relationship field with a value that is specific to the user, such as the word “mom”, “mother”, parent, some other synonym indicating that the person is the user's mom.

In some examples, in cases where local assistant module 122A does not have a structured/semantic record of the user's personal information (e.g. because local assistant module 122A had not successfully parsed the user's initial input and correctly recognized the word “Mom”), the assistant may perform a search (e.g., external to computing device 110, for instance on the Internet, or local to computing device 110, for example through the user's prior chat history, search history, etc.) to try and find that information. Upon finding the information via search, local assistant module 122A may add this new information to a record at data store 124A.

Local assistant module 122A may engage in a conversation with the user by causing UI module 120 to output audio or text via UID 112 “sure, I can help you with that . . . ” Since local assistant module 122A may have just created a person record for the personal contact that the user identifies as being “Mom”, the record may be incomplete. Local assistant module 122A may execute a search (e.g., amongst the entries of an address book stored locally or remotely to computing device 110) in an attempt to determine the identity of a specific person who could be identified as “Mom” in an effort to further populate the personal record. However, the search may fail to return any results for a specific person who could be identified as “Mom”. For example, if the telephone number of the user's mother is not stored in the address book under a contact entry labeled “Mom” or some synonym thereof, local assistant module 122A may fail to identify any identity of a specific person named “Mom” and therefore recognize the reference to “Mom” as an initial reference to personal information not previously associated with a value that is specific to the user.

After failing to obtain the identity of “Mom”, local assistant module 122A may request that the user provide additional input at UID 112 that may help local assistant module 122A identify the telephone number of the specific person that the user is referring to when the user refers to “Mom”. Local assistant module 122A may continue the conversation with the user by causing UI module 120 to output audio or text via UID 112 “but I can't seem to find a record for your mother, what is her name?”

The user may speak the word “Kat” and computing device 110 may receive the spoken word Kat as an additional voice input via UID 112. Local assistant module 122A may receive an indication of the additional voice input from UI module 120 in response to the user saying “Kat” and cause UI module 120 to output the transcription of the voice input “Kat” for display at UID 112.

Based on the indication of the additional input, local assistant module 122A may determine that “Mom” refers to a person named “Kat” and further populate a name field of the record being created with the name “Kat”. Local assistant module 122A may execute a subsequent search, for example, amongst the entries of the address book associated with the user of computing device 110, to determine the name of a specific person identified in the address book as “Kat”. In response to determining that the address book associated with the user of computing device 110 includes two or more contacts named “Katherine”, local assistant module 122A may consider each of the two or more contacts named Katherine as potential matching the name “Kat”.

To determine which of the two or more Katherine's is known to the user as “Mom”, local assistant module 122A may automatically infer that the contact named “Katherine” that also shares the same last name as the user is the specific person being referred to when the user refers to “Mom”. Local assistant module 122A may ask that the user confirm the assumption that the “Katherine” that also shares the same last name as the user is the specific person being referred to when the user refers to “Mom” is correct by causing UI module 120 and UID 112 to output text or audio requesting confirmation from the user.

In response to receiving an indication of a user input from UI module 120 indicating that the user of computing device has affirmed the assumption (e.g., a voice input provided by the user of computing device 110 when the user states the word “Yes”), local assistant module 122A may annotate the name field of the record initially created and stored at data store 124A to store data indicating the user's Mother is a person who's first name is “Katherine”, sometimes goes by “Kat”, and shares the same last name as the user. Local assistant module 122A may provide feedback to the user by causing UI module 120 and UID 112 to output text or audio indicating that local assistant module 122A has created a record to store the association between an entry in the address book and the user's Mom.

In some examples, local assistant module 122A may make an incorrect assumption. For example, local assistant module 122 may receive an indication of a user input from UI module 120 indicating that the user of computing device has rejected the assumption (e.g., a voice input provided by the user of computing device 110 when the user states the word “No”) (for example, if the user and the user's mother do not share the last name—as may be the case where the commonality between last names is due to marriage rather than birth right). In response to receiving the indication of the user input rejecting the assumption, local assistant module 122A may follow-up with additional questions to elicit the identity of the user's mother and eventually annotate the name field of the record initially created and stored at data store 124A once the identity of the user's mother is determined.

Local assistant module 122A may execute one or more operations to complete the task specified by the original voice input (e.g., to “telephone Mom”). For example, local assistant module 122A may cause computing device 110 to execute a telephone application to dial the telephone number stored in the address book associated with the user of computing device 110 under the entry whose first name is Katherine and whose last name is the same as the user.

After creating the personal record for the user's mom, local assistant module 122A may again receive, from UI module 120, an indication of a voice input from the user that refers to “Mom”. Local assistant module 122A may quickly parse or traverse the schema of the personal records stored at data store 124A for “Mom” and quickly identify the personal record previously created that provides information regarding who the user considers to be his mother. Local assistant module 122A may therefore need not execute a local or global search amongst multiple information sources stored locally or remotely from computing device 110 to determine the identity of “Mom”. Local assistant module 122A may have a much faster response time in responding to user input where the user input reference data contained in previously created personal records stored at data store 124A as compared to user inputs that reference data not contained in personal records.

In this way, during everyday conversations with the user, local assistant module 122A may automatically recognize and retain specific personal information that local assistant module 122A infers will likely be needed to complete a future task. Local assistant module 122A may maintain the personal information as personal records that are stored in a structured and semantic way at data store 124A to enable quick future retrievals of the information while local assistant module 122A is in the midst of a conversation with a user.

Among the several benefits provided by the aforementioned approach are: (1) the processing complexity and time for a device to act on a user input invoking personal data may be reduced; (2) private data may be stored locally reducing the need for complex and memory-consuming transmission security protocols on the user's device for the private data; (3) specific data is associated with user's preferred query phrasing, reducing demands on a user device for query rewriting and other computationally complex data retrieval, as well as improving result accuracy; and (4) network usage may be reduced as the data that the local assistant module needs to access may be obtained from local storage as opposed to a network resource.

While other assistants may need to repeatedly search amongst multiple (internal or external) information sources, or elicit additional user input, each time these other assistants are tasked to respond to a specific user need, an assistant according to the present disclosure may be able to more quickly ascertain what a user needs by relying on the personal records, and without having to search multiple information sources, begin taking action to satisfy the need. Since the personal records may be automatically generated during the course of regular conversations with a user, the user need not spend time manually programming the example assistant to learn about the user. An assistant according to the present disclosure may therefore complete tasks more quickly and/or respond to a user faster than other assistants. By executing faster, an example assistant may minimize pauses or hesitations in conversations with the user which may make conversing with the assistant seem natural, less awkward, and more desirable to the user.

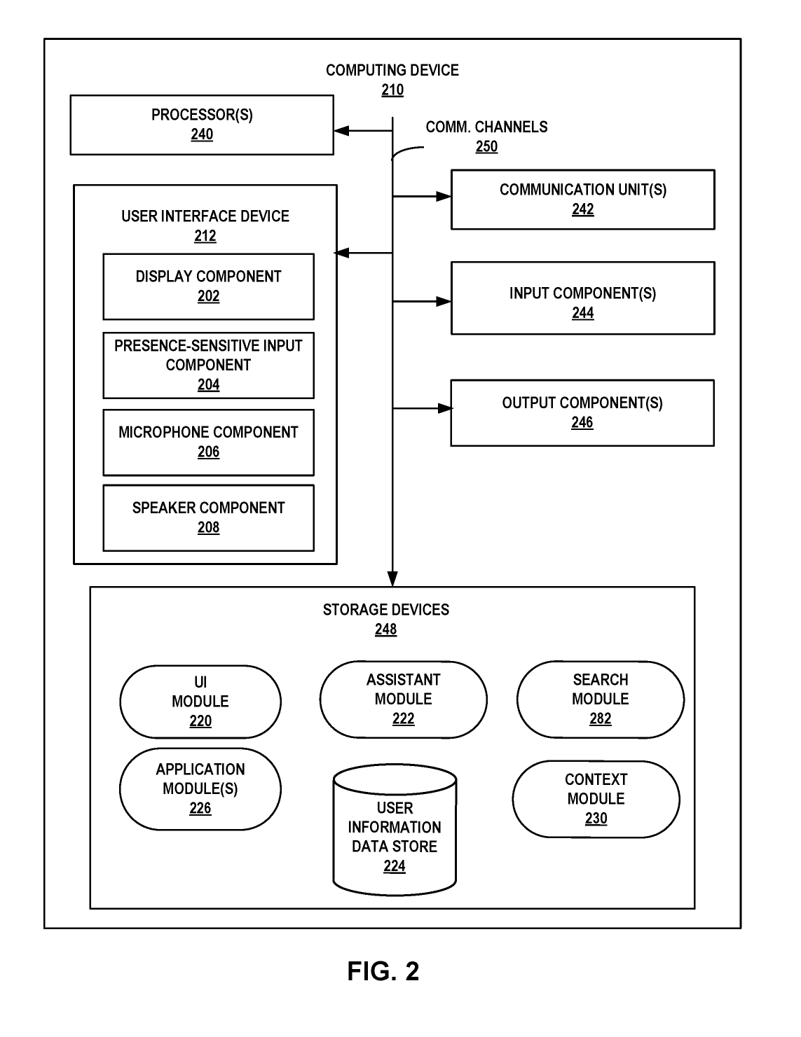

FIG. 2 is a block diagram illustrating an example computing device that is configured to execute an example virtual assistant, in accordance with one or more aspects of the present disclosure. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes user interface device (USD) 212, one or more processors 240, one or more communication units 242, one or more input components 244, one or more output components 246, and one or more storage components 248. USD 212 includes display component 202, presence-sensitive input component 204, microphone component 206, and speaker component 208. Storage components 248 of computing device 210 include UI module 220, assistant module 222, search module 282, one or more application modules 226, context module 230, and user information data store 224.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices (e.g., assistant server system 160 and/or search server system 180 of system 100 of FIG. 1) via one or more wired and/or wireless networks by transmitting and/or receiving network signals on one or more networks (e.g., network 130 of system 100 of FIG. 1). Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 246 of computing device 110 may generate output. Examples of output are tactile, audio, and video output. Output components 246 of computing device 210, in one example, includes a presence-sensitive display, sound card, video graphics adapter card, speaker, cathode ray tube (CRT) monitor, liquid crystal display (LCD), or any other type of device for generating output to a human or machine.

UID 212 of computing device 210 may be similar to UID 112 of computing device 110 and includes display component 202, presence-sensitive input component 204, microphone component 206, and speaker component 208. Display component 202 may be a screen at which information is displayed by USD 212 while presence-sensitive input component 204 may detect an object at and/or near display component 202. Speaker component 208 may be a speaker from which audible information is played by UID 212 while microphone component 206 may detect audible input provided at and/or near display component 202 and/or speaker component 208.

While illustrated as an internal component of computing device 210, UID 212 may also represent an external component that shares a data path with computing device 210 for transmitting and/or receiving input and output. For instance, in one example, UID 212 represents a built-in component of computing device 210 located within and physically connected to the external packaging of computing device 210 (e.g., a screen on a mobile phone). In another example, UID 212 represents an external component of computing device 210 located outside and physically separated from the packaging or housing of computing device 210 (e.g., a monitor, a projector, etc. that shares a wired and/or wireless data path with computing device 210).

As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface (such as graphical user interface 114 of FIG. 1).

Speaker component 208 may comprise a speaker built-in to a housing of computing device 210 and in some examples, may be a speaker built-in to a set of wired or wireless headphones that are operably coupled to computing device 210. Microphone component 206 may detect audible input occurring at or near UID 212. Microphone component 206 may perform various noise cancellation techniques to remove background noise and isolate user speech from a detected audio signal.

UID 212 of computing device 210 may detect two-dimensional and/or three-dimensional gestures as input from a user of computing device 210. For instance, a sensor of UID 212 may detect a user's movement (e.g., moving a hand, an arm, a pen, a stylus, etc.) within a threshold distance of the sensor of UID 212. UID 212 may determine a two or three-dimensional vector representation of the movement and correlate the vector representation to a gesture input (e.g., a hand-wave, a pinch, a clap, a pen stroke, etc.) that has multiple dimensions. In other words, UID 212 can detect a multi-dimension gesture without requiring the user to gesture at or near a screen or surface at which UID 212 outputs information for display. Instead, UID 212 can detect a multi-dimensional gesture performed at or near a sensor which may or may not be located near the screen or surface at which UID 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 226, 230, and 282 may be operable by processors 240 to perform various actions, operations, or functions of computing device 210. For example, processors 240 of computing device 210 may retrieve and execute instructions stored by storage components 248 that cause processors 240 to perform the operations modules 220, 222, 226, 230, and 282. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 226, 230, and 282 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 226, 230, and 282 and data store 224. Storage components 248 may include a memory configured to store data or other information associated with modules 220, 222, 226, 230, and 282 and data store 224.

UI module 220 may include all functionality of UI module 120 of computing device 110 of FIG. 1 and may perform similar operations as UI module 120 for managing a user interface (e.g., user interface 114) that computing device 210 provides at USD 212 for example, for facilitating interactions between a user of computing device 110 and assistant module 222. For example, UI module 220 of computing device 210 may receive information from assistant module 222 that includes instructions for outputting (e.g., displaying or playing audio) an assistant user interface (e.g., user interface 114). UI module 220 may receive the information from assistant module 222 over communication channels 250 and use the data to generate a user interface. UI module 220 may transmit a display or audible output command and associated data over communication channels 250 to cause UID 212 to present the user interface at UID 212.

In some examples, UI module 220 may receive an indication of one or more user inputs detected at UID 212 and may output information about the user inputs to assistant module 222. For example, UID 212 may detect a voice input from a user and send data about the voice input to UI module 220.

UI module 220 may send an indication of the voice input to assistant module 222 for further interpretation. Assistant module 222 may determine, based on the voice input, that the detected voice input represents a user request for assistant module 222 to perform one or more tasks.

Application modules 226 represent all the various individual applications and services executing at and accessible from computing device 210 that may be accessed by an assistant, such as assistant module 222, to provide user with information and/or perform a task. A user of computing device 210 may interact with a user interface associated with one or more application modules 226 to cause computing device 210 to perform a function. Numerous examples of application modules 226 may exist and include, a fitness application, a calendar application, a search application, a map or navigation application, a transportation service application (e.g., a bus or train tracking application), a social media application, a game application, an e-mail application, a chat or messaging application, an Internet browser application, or any and all other applications that may execute at computing device 210.

Search module 282 of computing device 210 may perform integrated search functions on behalf of computing device 210. Search module 282 may be invoked by UI module 220, one or more of application modules 226, and/or assistant module 222 to perform search operations on their behalf. When invoked, search module 282 may perform search functions, such as generating search queries and executing searches based on generated search queries across various local and remote information sources. Search module 282 may provide results of executed searches to the invoking component or module. That is, search module 282 may output search results to UI module 220, assistant module 222, and/or application modules 226 in response to an invoking command.

Context module 230 may collect contextual information associated with computing device 210 to define a context of computing device 210. Specifically, context module 210 is primarily used by assistant module 222 to define a context of computing device 210 that specifies the characteristics of the physical and/or virtual environment of computing device 210 and a user of computing device 210 at a particular time.

As used throughout the disclosure, the term “contextual information” is used to describe any information that can be used by context module 230 to define the virtual and/or physical environmental characteristics that a computing device, and the user of the computing device, may experience at a particular time. Examples of contextual information are numerous and may include: sensor information obtained by sensors (e.g., position sensors, accelerometers, gyros, barometers, ambient light sensors, proximity sensors, microphones, and any other sensor) of computing device 210, communication information (e.g., text based communications, audible communications, video communications, etc.) sent and received by communication modules of computing device 210, and application usage information associated with applications executing at computing device 210 (e.g., application data associated with applications, Internet search histories, text communications, voice and video communications, calendar information, social media posts and related information, etc.). Further examples of contextual information include signals and information obtained from transmitting devices that are external to computing device 210. For example, context module 230 may receive, via a radio or communication unit of computing device 210, beacon information transmitted from external beacons located at or near a physical location of a merchant.

Assistant module 222 may include all functionality of local assistant module 122A of computing device 110 of FIG. 1 and may perform similar operations as local assistant module 122A for providing an assistant. In some examples, assistant module 222 may execute locally (e.g., at processors 240) to provide assistant functions. In some examples, assistant module 222 may act as an interface to a remote assistant service accessible to computing device 210. For example, assistant module 222 may be an interface or application programming interface (API) to remote assistant module 122B of assistant server system 160 of FIG. 1.

Similar to data stores 124A and 124B of system 100 of FIG. 1, user information data store 224 may store personal records created by assistant module 222 that includes information that assistant module 222 has learned about the user of computing device 210 during conversations between the user and an assistant provided by assistant module 222. Assistant module 222 may rely on the information stored at data store 224, in addition to any information provided by context module 230 and/or search module 282, to perform assistant tasks.

The information contained within data store 224 may be stored in structured and semantic fashion. For example, in response to detecting a voice input at UID 212 “my name is john”, assistant module 222 may produce a record at data store 224 containing a name field populated by a character string “john” (e.g., (name, john)). In addition to the name field, assistant module 222 may cause the record stored by data store 224 to also include contextual information received from context module 230 at the time that the voice input is received (e.g., information such as date, location of computing device 210, and other contextual information).

As another example, during chat conversation between the user and an assistant provided by assistant module 222, the user may provide input at UID 212 that is recognized by UID 212 as a string of text “I'm a reference clerk at the local library”. Assistant module 222 may receive an indication of the string of text and create a personal record at data store 224 containing an occupation field. Assistant module 222 may populate the occupation field with a type and a location inferred from the user input. For example, the occupation field may include a type reference as “reference_clerk” and a place of employment reference as an entity “Springfield Ohio Public Library” (e.g., (occupation, \type reference_clerk) and (place_of_employment, \entity Springfield_Ohio_Public_Library)). Assistant module 222 may populate the fields of the personal records stored by data store 224 with well-defined, normalized and consistent representations of information for those underlying semantics.

Assistant module 222 may recognize that information obtained during a conversation with a user may be associated with a regular schema that conveys a broader structure. Assistant module 222 may create a record according to the broader structure with null or empty placeholders if assistant module 222 has not yet elicited from the user the information required to populate all the fields of the broader structure. As assistant module 222 converses with the user more and more, assistant module 222 may populate the fields of the personal records at data store 224 to make future interactions easier and faster.

For example, assistant module 222 may operate according to a rule specifying that in addition to names, people frequently have birth dates, home locations and places of employment. In response to generating a personal record at data store 224 in response to an input “my name is john” assistant module 222 may cause UID 212 to output “hi john, nice to meet you, where do you work?”, and store the resulting user response received by UID 212 build a more complete understanding of the user assistant module 222 is helping. Operating according to such a secondary information elicitation, assistant module 222 may be guided in outputting further elicitations by rules assistant module 222 operates under. Such rules may include rules regarding the importance and/or popularity of a particular secondary characteristic, whether the user has been asked such questions recently, whether they have tended to answer them in the past, and so on.

In operation, a user of computing device 210 may provide a voice input at UID 212 that instructs assistant module 222 in a relatively unprompted manner. For example, the user might provide a voice input as “my name is John”, “I have two cats and a dog”, “I'm a reference clerk at the local library”, “I like baseball, and my favorite team is the Red Sox”, “my brother's name is Ted”, and so on.

In some examples, assistant module 222 may elicit information from the user of computing device 210 as part of an ongoing task. For example, the user of computing device 210 might provide voice input as “what's traffic like today”, and assistant module 222 may cause UI module 220 and UID 212 to output and audible or a graphical indication of “I can check that for you, where do you work?” The user of computing device 210 might also provide voice input to ask assistant module 222 “what's going on in the world?”, and local assistant module 222 may cause UI module 220 and UID 212 to output and audible or a graphical indication of “where do you prefer to get your news from?”

In some examples, local assistant module 222 may have access to other information (such as address books, location histories, communications, etc. that may or may not be maintained by application modules 226 and/or context module 230) that may provide a plausible but unconfirmed answer to the information assistant module 222 needs to complete a task. For example, if the user asks for the traffic to work, the location history associated with the user and maintained by a navigation application of application modules 226 might contain evidence indicating where the user drives to each day. Assistant module 222 might use that destination to ask “I can check that for you. From your location history it looks like you work at the Springfield Library. Is that right?” This information may come from a variety of sources the Assistant has been given access to, including location history, search or browsing activity, email, chat or other correspondence with the assistant or other entities, social networks or other services associated with the user.

Assistant module 222 may perform refinements to information elicited from a user to resolve ambiguity. For instance, there may be two local libraries, for example, and assistant module 222 may prompt the user to indicate which one is correct. Or the user's name may have homonyms, and assistant module 222 may output information via UID 212 to ask which the correct spelling is. Assistant module 222 may cause UI module 220 to provide visual elements at UID 212, such as a list of alternatives, a map with a pin, or pictures/cards with additional differentiating details to determine the most useful and accurate answer. Once personal information has been provided and understood, assistant module 222 may store the personal information as one or more personal records at data store 224.

If appropriate, assistant module 222 may use information that has just been stored at data store 224 to complete a task. For example, assistant module 222 may cause UI module 220 to output at UID 212 an audible or graphical indication stating “Ok, I'll remember you work there. The traffic looks heavy today, it will take 40 minutes to get to work”.

In some examples, if there was no ongoing task, assistant module 222 may provide examples of how assistant module 222 can use information recently stored at data store 224 to help the user at a future time. For example, assistant module 222 may cause UI module 220 to output at UID 212 an audible or graphical indication stating “Ok, I'll remember you like the lions, do you want me to send you the scores when they play?” Or, “Ok, I'll remember your brother's name is Ted. From now on, you can say ‘call my brother’ to reach him”. In some examples, assistant module 222 can recognize when personal references, such as “my brother”, “work” and “my dog” are used, and substitute the correct personal interpretation based on information stored at data store 224 so that assistant module 222 can accurately and successfully complete a task.

Assistant module 222 may provide the user of computing device 210 an opportunity to choose to cause assistant module 222 to forget or modify information stored at data store 224. For example, assistant module 222 may recognize a voice command detected by UI module 220 and UID 212 that recites the phrase “forget that I work at the library”, “I've changed my name to John Smith” or “I don't like baseball anymore”, or “what have I told you about my friend Peter” and follow-up by saying “please forget all of that”. In response to such a command, assistant module 222 may alter the personal records stored at data store 224 to remove the information specified by the removal command. Assistant module 222 may also provide a settings menu or other graphical user interface from which a user can customize or manually remove particular information being stored at data store 224.

Assistant module 222 may also manage conflicts with respect to data stored at data store 224. For example, if a user previously provided the input “my name is Jon”, then later provided the input “my name is Jonathan”, assistant module may: (a) store both “Barb” and “Barbara” as values that are specific to the user for the user's name, (b) ask the user for clarification, such as whether he wishes to store one name as a value for a nick name, overwrite the value of one name, and so on; (c) check an external resource to determine which data to utilize; (d) follow some other predefined protocol such as a default to always overwrite older data with new data; etc.

Assistant module 222 may automatically supplement the information stored at data store 224 with information that assistant module 222 gathers from various information sources. In other words, while assistant module 222 may in some examples elicit further information from a user of computing device 210 to populate empty fields in a personal record at data store 224, in some examples, assistant module 222 may involve search module 282 and context module 230 to populate various pieces of information. For example, assistant module 222 may populate missing fields in a personal record with information assistant module 222 obtains from an address book, a location history, email or messages, a social media account, or any other information source that is accessible via search module 282, context module 230, and/or one or more of application modules 226. So as to not slow execution of the assistant service, assistant module 222 may delay supplementing personal records stored at data store 224 until a break in a conversation with a user.

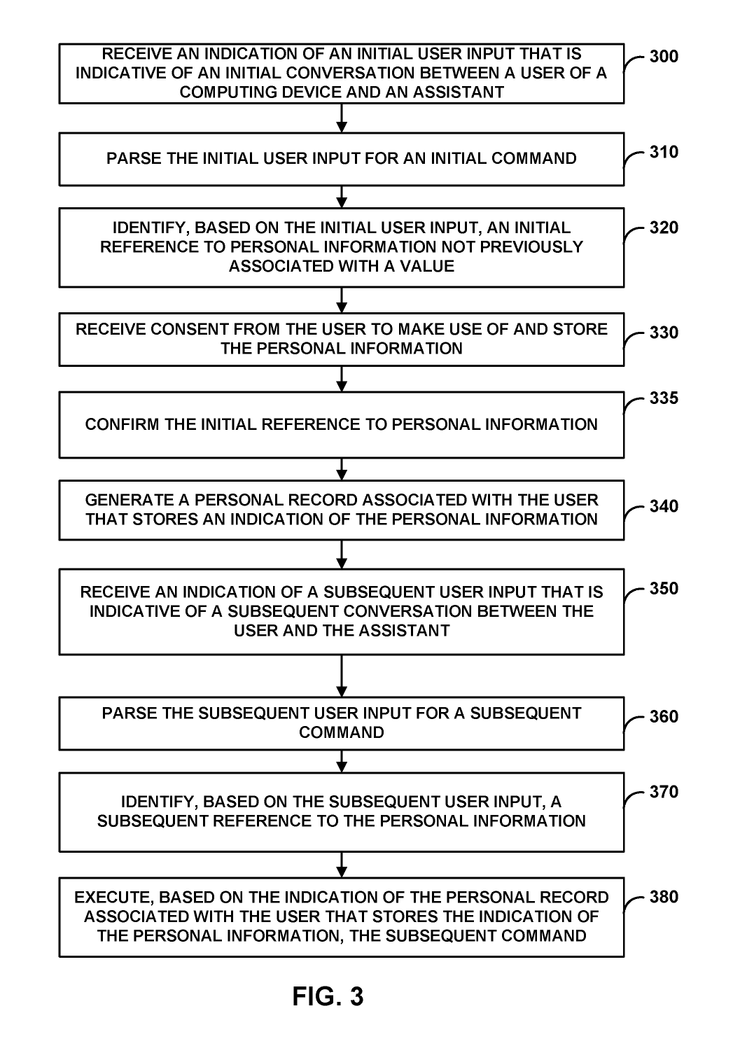

FIG. 3 is a flowchart illustrating example operations performed by one or more processors executing an example virtual assistant, in accordance with one or more aspects of the present disclosure. FIG. 3 is described below in the context of system 100 of FIG. 1. For example, local assistant module 122A while executing at one or more processors of computing device 110 may perform operations 300-380, in accordance with one or more aspects of the present disclosure. And in some examples, remote assistant module 122B while executing at one or more processors of assistant server system 160 may perform operations 300-380, in accordance with one or more aspects of the present disclosure. For purposes of illustration only, FIG. 3 is described below within the context of computing device 110 of FIG. 1.

In operation, computing device 110 may receive an indication of an initial user input that is indicative of an initial conversation between a user of a computing device and an assistant (300). For example, a user of computing device 110 may provide a voice input at UID 112 that is received by local assistant module 122A as “when does our dentist open”.

Computing device 110 may parse the initial user input for an initial command (310). For instance, local assistant module 122A may determine, using natural language processing and/or machine learning techniques, that the voice input indicates a request for information (e.g., an opening time) related to a business (e.g., our dentist).

While parsing the initial user input for the initial command (310), computing device 110 may identify, based on the initial user input, an initial reference to personal information not previously associated with a value (320) that is specific to the user. For example, local assistant module 122A may recognize “our dentist” as being an indicator of a piece of personal information that may be worth keeping in a personal record maintained at data store 124A. Local assistant module 122A may quickly parse the schema of data store 124A and determine that no record of a dentist associated with the user exists at data store 124A. In response, local assistant module 122A may determine that “dentist” is not previously associated with any value that is specific to the user (e.g., a personal record).

In some examples, computing device 110 may identify an initial reference to personal information not previously associate with a value that is specific to the user by determining that the reference to the personal information has not been referenced during any previous conversations between the user and the assistant. In other examples, while the reference may have previously been made, local assistant module 122A may not have deemed the reference important enough to record the personal information as part of a personal record and therefore the value stored by local assistant module 122A may correspond to a zero, null, or other default value that is not specific to the user.

Computing device 110 may receive consent from the user to make use of and store the personal information (330). For instance, prior to the above interactions, or in response to identifying potential personal information, local assistant module 122A may cause UI module 120 to request permission from the user to store and make use of personal information obtained during interactions with local assistant module 122A and the user. It should be understood that computing device 110 may not require a user to consent prior to each time that local assistant module wants to make use of or store personal information. For example, if computing device 110 receives consent once a year, once a day, or even just one time (e.g., after initial product purchase, set up, etc.) computing device 110 may treat that prior consent as consent to make use and store personal information in the future. As one example of how a user may provide consent, the user may provide a voice input “yeah that's ok to store information about me” and in response to the voice input, local assistant module 122A may begin maintaining personal records about the user at data store 122A.

Computing device 110 may confirm the initial reference to personal information (335) by posing a question to the user confirming as much. In other words, Local assistant module 122A may cause UI module 120 and UID 112 to output a request for confirmation of the value that is specific to the user and receive a user confirmation of the value that is specific to the user. That is, since no record of the user's dentist exists in data store 122A, local assistant module 122A may cause UI module 120 and UID 112 to output text or audio of a question “who is your dentist?”.

In response to outputting the question, computing device 110 may receive a voice input from the user that recites “my dentist is Dr. Smiley Dentist”. In response to the voice input, local assistant module 122A may determine that the user's dentist “Dr. Smiley Dentist” and cause UI module 120 and UID 112 to output a confirmation as text or audio stating “Got it, your dentist is Dr. Smiley Dentist in Springfield USA.”

Computing device 110 may generate a personal record associated with the user that stores an indication of the personal information (340). For example, to preserve the knowledge that local assistant module 122A gained about the user's dentist, local assistant module 122A may create a field in a new or an already existing data structure of personal information associated with the user of computing device 110 to store information about the user's dentist. In other words, local assistant module 122A may create a personal record according to a predefined schema that specifies a plurality of fields for storing information about persons, places, things, or other entities.

When creating a personal record, local assistant module 122A may determine a particular field from the plurality of fields for storing the value that is specific to the user and responsive to determining the particular field is not associated with any value that is specific to the user, local assistant module 122A may populate the particular field with the value that is specific to the user. For instance, in response to determining that the dentist field include a null value, zero value, or otherwise does not include any value that is specific to the user, local assistant module 122A may store sufficient information at the dentist field of the personal record to enable local assistant module 122A to quickly ascertain what the user of computing device 110 is referring to when he or she refers to his “dentist”. For example, the dentist field may include a business name, a link to information online (e.g., a website), an address, a telephone number, etc.

Upon generating the record of the user's dentist, computing device 110 may finish completing the task associated with the initial user input. For example, since the initial user input was a request from the user for information about an opening time of his or her dentist, local assistant module 122A may cull the information stored at the personal record associated with the user's dentist for hours of operation. In response to identifying an opening time, local assistant module 122A may cause UI module 120 and UID 112 to output an indication of the dentist office's hours of operation (e.g., “your dentist is open at 7 AM today—would you like to telephone the office?”).

Computing device 110 may receive an indication of a subsequent user input that is indicative of a subsequent conversation between the user and the assistant (350). For example, at a later point in time, the user of computing device 110 may provide a voice input at UID 112 that is received by local assistant module 122A again as “what's the traffic like to get to the dentist”. In some examples, the subsequent user input may have already been received as part of receiving the indication of the initial user input. For example, the subsequent user input received as part of the initial user input may be the command “remind me to call them to cancel my appointment.” So the entire input received by local assistant module 122A may be “when does our dentist open, remind me to call them to cancel my appointment.”

Computing device 110 may parse the subsequent user input for a subsequent command (360). For instance, local assistant module 122A may determine, using natural language processing and/or machine learning techniques, that the voice input indicates a request for information (e.g., an estimated travel time) related to a business (e.g., the dentist) or as indicated above, a command to set a reminder for the user to call the business.

While or after parsing the subsequent user input for the subsequent command, computing device 100 may identify, based on the subsequent user input, a subsequent reference to the personal information (370). For instance, since “the dentist” is ambiguous without some context (there are many dentist offices all over the world, not just one), local assistant module 122A may parse through the personal records of data store 124A to see if the user has a dentist. Local assistant module 122A may identify the personal record previously created in response to the previous voice input and from the personal record, determine a location of the user's dentist office.

Computing device 110 may execute, based on the indication of the personal record associated with the user that stores the indication of the personal information, the subsequent command (380). For example, local assistant module 122A may invoke search module 182 of search server system 180 to determine an estimated duration of travel from a current location of computing device 110 to the location of the user's dentist office. Local assistant module 122A may receive an indication of the estimated duration of travel from search server system 180. Local assistant module 122A may cause UI module 120 to output using UID 112 an audible and/or graphical indication of the estimated duration as “Traffic is moderate - it will take you approximately 17 minutes if you leave now to travel from your current location to Dr. Smiley Dentist in Springfield USA.”

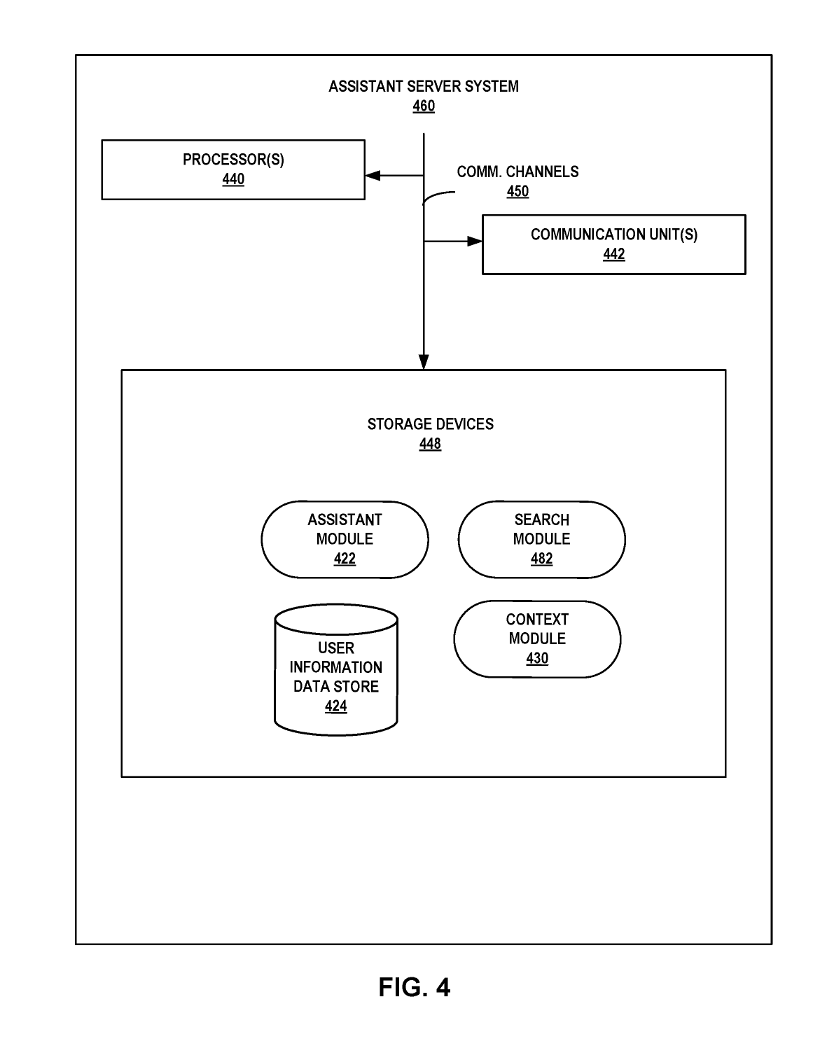

FIG. 4 is a block diagram illustrating an example computing system that is configured to execute an example virtual assistant, in accordance with one or more aspects of the present disclosure. Assistant server system 460 of FIG. 4 is described below as an example of assistant server system 160 of FIG. 1. FIG. 4 illustrates only one particular example of assistant server system 460, and many other examples of assistant server system 460 may be used in other instances and may include a subset of the components included in example assistant server system 460 or may include additional components not shown in FIG. 4.

As shown in the example of FIG. 4, assistant server system 460 includes user one or more processors 440, one or more communication units 442, and one or more storage components 448. Storage components 448 include assistant module 422, search module 482, context module 430, and user information data store 424.

Processors 440 are analogous to processors 240 of computing system 210 of FIG. 2. Communication units 442 are analogous to communication units 242 of computing system 210 of FIG. 2. Storage devices 448 are analogous to storage devices 248 of computing system 210 of FIG. 2. Communication channels 450 are analogous to communication channels 250 of computing system 210 of FIG. 2 and may therefore interconnect each of the components 440, 442, and 448 for inter-component communications. In some examples, communication channels 450 may include a system bus, a network connection, an inter-process communication data structure, or any other method for communicating data.

Search module 482 of assistant server system 460 is analogous to search module 282 of computing device 210 and may perform integrated search functions on behalf of assistant server system 460. That is, search module 482 may perform search operations on behalf of assistant module 422. In some examples, search module 482 may interface with external search systems, such as search server system 180 to perform search operations on behalf of assistant module 422. When invoked, search module 482 may perform search functions, such as generating search queries and executing searches based on generated search queries across various local and remote information sources. Search module 482 may provide results of executed searches to the invoking component or module. That is, search module 482 may output search results to assistant module 422.

Context module 430 of assistant server system 460 is analogous to context module 230 of computing device 210. Context module 430 may collect contextual information associated with computing devices, such as computing device 110 of FIG. 1 and computing device 210 of FIG. 2, to define a context of the computing device. Context module 430 may primarily be used by assistant module 422 and/or search module 482 to define a context of a computing device interfacing and accessing a service provided by assistant server system 160. The context may specify the characteristics of the physical and/or virtual environment of the computing device and a user of the computing device at a particular time.

Assistant module 422 may include all functionality of local assistant module 122A and remote assistant module 122B of FIG. 1, as well as assistant module 222 of computing device 210 of FIG. 2. Assistant module 422 may perform similar operations as remote assistant module 122B for providing an assistant service that is accessible via assistant server system 460. That is, assistant module 422 may act as an interface to a remote assistant service accessible to a computing device that is communicating over a network with assistant server system 460. For example, assistant module 422 may be an interface or API to remote assistant module 122B of assistant server system 160 of FIG. 1.

User information data store 424 is analogous to user information data store 224 of FIG. 2 and is configured to store personal records created by assistant module 422 that includes information that assistant module 422 has learned about the user of a computing device during conversations between the user and an assistant provided by assistant module 422. Assistant module 422 may rely on the information stored at data store 424, in addition to any information provided by context module 430 and/or search module 482, to perform assistant tasks.

For example, the following represents various scenarios between a user of computing device 110 of FIG. 1 and an assistant provided by assistant module 422. For each scenario, there is some initial exchange of information between the user and the assistant, and one or more examples are provided indicating how this will impact the user's experience.

Clause 1. A method comprising: receiving, by an assistant executing at one or more processors, an indication of an initial user input that is indicative of an initial conversation between a user of a computing device and the assistant; parsing, by the assistant, the initial user input to identify an initial command; identifying, by the assistant, based on the initial user input, an initial reference to personal information not previously associated with a value that is specific to the user; generating, by the assistant, a personal record associated with the user that stores the value that is specific to the user and executing, by the assistant, based on the value that is specific to the user, the initial command.

Clause 2. The method of clause 1, further comprising: receiving, by the assistant, an indication of a subsequent user input that is indicative of a subsequent conversation between the user and the assistant; parsing, by the assistant, the subsequent user input for a subsequent command; identifying, by the assistant, based on the subsequent user input, a subsequent reference to the personal information; and executing, by the assistant, based on the value that is specific to the user, the subsequent command.

Clause 3. The method of any one of clauses 1-2, further comprising: causing, by the assistant, the computing device to output a request for confirmation of the value that is specific to the user; and receiving, by the assistant, a user confirmation of the value that is specific to the user.

Clause 4. The method of any one of clauses 1-3, wherein generating the personal record comprises: creating, by the assistant, the personal record according to a predefined schema that specifies a plurality of fields; determining, by the assistant, a particular field from the plurality of fields for storing the value that is specific to the user; and responsive to determining the particular field is not associated with any value that is specific to the user, populating, by the assistant, the particular field with the value that is specific to the user.

Clause 5. The method of any one of clauses 1-4, further comprising: determining, by the assistant, whether the initial user input is a public request or a personal request, wherein the initial reference to personal information is identified in response to determining that the initial user input is a personal request.

Clause 6. The method of clause 5, further comprising: responsive to determining that the initial user input is a personal request, parsing, by the assistant, the personal record associated with the user for the personal information, wherein the initial reference to personal information is identified in response to determining that the personal record comprises a null or zero value in a field associated with the personal information.

Clause 7. The method of any one of clauses 5-6, further comprising: responsive to determining that the initial user input is a public request, executing, by the assistant, a public search for information to execute the initial command.

Clause 8. The method of any one of clauses 5-7, further comprising: determining, by the assistant, that the initial user input is a public request in response to identifying one or more public entities or public content from the initial user input; and determining, by the assistant, that the initial user input is a private request in response to identifying one or more private entities or private content from the initial user input.

Clause 9. The method of clause 8, wherein the one or more private entities or private content comprises one or more familial terms, personal pronouns, fields of the personal record.

Clause 10. The method of any one of clauses 1-9, further comprising: receiving, by the assistant, an indication of a subsequent user input that is indicative of a subsequent conversation between the user and the assistant; and parsing, by the assistant, the subsequent user input to identify a subsequent command; identifying, by the assistant, based on the subsequent user input, a command to modify the personal information; modifying, by the assistant, based on the subsequent user input, the value that is specific to the user.

Clause 11. The method of any one of clauses 1-10, wherein the computing device comprises the one or more processors or a computing system comprises the one or more processors.

Clause 12. A computing device comprising: a user interface device; at least one processor; and at least one memory comprising instructions that when executed, cause the at least one processor to provide an assistant configured to: receive, from the user interface device, an indication of an initial user input that is indicative of an initial conversation between a user of the computing device and the assistant; parse the initial user input to identify an initial command; identify, based on the initial user input, an initial reference to personal information not previously associated with a value that is specific to the user; generate, at the at least one memory, a personal record associated with the user that stores the value that is specific to the user; and execute, based on the value that is specific to the user, the initial command.

Clause 13. The computing device of clause 12, wherein the assistant is further configured to: receive an indication of a subsequent user input that is indicative of a subsequent conversation between the user and the assistant; parse the subsequent user input for a subsequent command; identifying, based on the subsequent user input, a subsequent reference to the personal information; retrieve, from the at least one memory, the value that is specific to the user; and executing, by the assistant, based on the value that is specific to the user, the subsequent command.

Clause 14. The computing device of any one of clauses 12-13, wherein the assistant is further configured to: output, at the user interface device, a request for confirmation of the value that is specific to the user; and receive, from the user interface device, a user confirmation of the value that is specific to the user.

Clause 15. The computing device of any one of clauses 12-14, wherein the assistant is further configured to: create the personal record according to a predefined schema that specifies a plurality of fields; determine a particular field from the plurality of fields for storing the value that is specific to the user; and responsive to determining the particular field is not associated with any value that is specific to the user, populate the particular field with the value that is specific to the user.

Clause 16. The computing device of any one of clauses 12-15, wherein the assistant is further configured to: determine whether the initial user input is a public request or a personal request; responsive to determining that the initial user input is a personal request, parse the personal record associated with the user for the personal information, wherein the initial reference to personal information is identified in response to determining that the personal record comprises a null or zero value in a field associated with the personal information; and responsive to determining that the initial user input is a public request, execute a public search for information to execute the initial command.

Clause 17. The computing device of any one of clauses 12-16, wherein the computing device comprises a mobile phone, a tablet computer, a computerized watch, a home assistant device, a television, a server, a laptop computer, a gaming system, or an automobile system.

Clause 18. A computer-readable storage medium comprising instructions that, when executed, cause at least one processor of an assistant server system to: receive, from a mobile computing device, an indication of an initial user input that is indicative of an initial conversation between a user of the mobile computing device and an assistant executing at the mobile computing device; parse the initial user input to identify an initial command; identify, based on the initial user input, an initial reference to personal information not previously associated with a value that is specific to the user; generate, a memory of the assistant server system, a personal record associated with the user that stores the value that is specific to the user; and execute, based on the value that is specific to the user, the initial command.

Clause 19. The computer-readable storage medium of clause 19, wherein the instructions, when executed, further cause the at least one processor to: receive an indication of a subsequent user input that is indicative of a subsequent conversation between a user of a home automation device and an assistant executing at the home automation device; parse the subsequent user input for a subsequent command; identifying, based on the subsequent user input, a subsequent reference to the personal information; retrieve, from the at least one memory, the value that is specific to the user; and executing, by the assistant, based on the value that is specific to the user, the subsequent command.

Clause 20. The computer-readable storage medium of clause 19, wherein the user of the mobile computing device is the user of the home automation device.

Clause 21. A computing device comprising means for performing the method of any one of clauses 1-11.

Clause 22. A computing device comprising at least one processor and at least one memory comprising instructions that when executed, cause the at least one processor to perform the method of any one of clauses 1-11.

Clause 23. A computer-readable storage medium comprising instructions that, when executed cause at least one processor of a computing device to perform the method of any one of clauses 1-11.

Clause 24. A computing device comprising means for performing the method of any one of clauses 1-11.

Clause 25. A computing system comprising at least one processor and at least one memory comprising instructions that when executed, cause the at least one processor to perform the method of any one of clauses 1-11.

Clause 26. A computer-readable storage medium comprising instructions that, when executed cause at least one processor of a computing system to perform the method of any one of clauses 1-11.

In one or more examples, the functions described may be implemented in hardware, software, firmware, or any combination thereof If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method comprising:
receiving, by an assistant executing at one or more processors, an indication of an initial user input that is indicative of an initial conversation between a user of a computing device and the assistant;
parsing, by the assistant, the initial user input to identify an initial command;
identifying, by the assistant, based on the initial user input, an initial reference to personal information not previously associated with a value that is specific to the user;
generating, by the assistant, a personal record associated with the user that stores the personal information as the value that is specific to the user; and
executing, by the assistant, based on the value, the initial command.

2. The method of claim 1, further comprising:
receiving, by the assistant, an indication of a subsequent user input that is indicative of a subsequent conversation between the user and the assistant;
parsing, by the assistant, the subsequent user input for a subsequent command;
identifying, by the assistant, based on the subsequent user input, a subsequent reference to the personal information; and
executing, by the assistant, based on the value, the subsequent command.

3. The method of claim 1, further comprising:
causing, by the assistant, the computing device to output a request for confirmation of the value that is specific to the user; and
receiving, by the assistant, a user confirmation of the value that is specific to the user.

4. The method of claim 1, wherein generating the personal record comprises:
creating, by the assistant, the personal record according to a predefined schema that specifies a plurality of fields;
determining, by the assistant, a particular field from the plurality of fields for storing the value that is specific to the user; and
responsive to determining the particular field is not associated with any value that is specific to the user, populating, by the assistant, the particular field with the value that is specific to the user.

5. The method of claim 1, further comprising:
determining, by the assistant, whether the initial user input is a public request or a personal request, wherein the initial reference to personal information is identified in response to determining that the initial user input is a personal request.

6. The method of claim 5, further comprising:
responsive to determining that the initial user input is a personal request, parsing, by the assistant, the personal record associated with the user for the personal information, wherein the initial reference to personal information is identified in response to determining that the personal record comprises a null or zero value in a field associated with the personal information.

7. The method of claim 5, further comprising:
responsive to determining that the initial user input is a public request, executing, by the assistant, a public search for information to execute the initial command.

8. The method of claim 5, further comprising:
determining, by the assistant, that the initial user input is a public request in response to identifying one or more public entities or public content from the initial user input; and
determining, by the assistant, that the initial user input is a private request in response to identifying one or more private entities or private content from the initial user input.

9. The method of claim 8, wherein the one or more private entities or private content comprises one or more familial terms, personal pronouns, fields of the personal record.

10. The method of claim 1, further comprising:
receiving, by the assistant, an indication of a subsequent user input that is indicative of a subsequent conversation between the user and the assistant; and
parsing, by the assistant, the subsequent user input to identify a subsequent command;
identifying, by the assistant, based on the subsequent user input, a command to modify the personal information;
modifying, by the assistant, based on the subsequent user input, the value that is specific to the user.

11. The method of claim 1, wherein the computing device comprises the one or more processors or a computing system comprises the one or more processors.

12. A computing device comprising:
a user interface device;
at least one processor; and
at least one memory comprising instructions that when executed, cause the at least one processor to provide an assistant configured to:
receive, from the user interface device, an indication of an initial user input that is indicative of an initial conversation between a user of the computing device and the assistant;
parse the initial user input to identify an initial command;
identify, based on the initial user input, an initial reference to personal information not previously associated with a value that is specific to the user;
generate, at the at least one memory, a personal record associated with the user that stores the value that is specific to the user; and
execute, based on the value, the initial command.

13. The computing device of claim 12, wherein the assistant is further configured to:
receive an indication of a subsequent user input that is indicative of a subsequent conversation between the user and the assistant;
parse the subsequent user input for a subsequent command;
identifying, based on the subsequent user input, a subsequent reference to the personal information;
retrieve, from the at least one memory, the value that is specific to the user; and
executing, by the assistant, based on the value that is specific to the user, the subsequent command.

14. The computing device of claim 12, wherein the assistant is further configured to:
output, at the user interface device, a request for confirmation of the value that is specific to the user; and
receive, from the user interface device, a user confirmation of the value that is specific to the user.

15. The computing device of claim 12, wherein the assistant is further configured to:
create the personal record according to a predefined schema that specifies a plurality of fields;
determine a particular field from the plurality of fields for storing the value that is specific to the user; and
responsive to determining the particular field is not associated with any value that is specific to the user, populate the particular field with the value that is specific to the user.

16. The computing device of claim 12, wherein the assistant is further configured to:
determine whether the initial user input is a public request or a personal request;
responsive to determining that the initial user input is a personal request, parse the personal record associated with the user for the personal information, wherein the initial reference to personal information is identified in response to determining that the personal record comprises a null or zero value in a field associated with the personal information; and
responsive to determining that the initial user input is a public request, execute a public search for information to execute the initial command.

17. The computing device of claim 12, wherein the computing device comprises a mobile phone, a tablet computer, a computerized watch, a home assistant device, a television, a server, a laptop computer, a gaming system, or an automobile system.

18. A computer-readable storage medium comprising instructions that, when executed, cause at least one processor of an assistant server system to:
receive, from a mobile computing device, an indication of an initial user input that is indicative of an initial conversation between a user of the mobile computing device and an assistant executing at the mobile computing device;
parse the initial user input to identify an initial command;
identify, based on the initial user input, an initial reference to personal information not previously associated with a value that is specific to the user;
generate, a memory of the assistant server system, a personal record associated with the user that stores the value that is specific to the user; and
execute, based on the value that is specific to the user, the initial command.

19. The computer-readable storage medium of claim 18, wherein the instructions, when executed, further cause the at least one processor to:
receive an indication of a subsequent user input that is indicative of a subsequent conversation between a user of a home automation device and an assistant executing at the home automation device;
parse the subsequent user input for a subsequent command;
identifying, based on the subsequent user input, a subsequent reference to the personal information;
retrieve, from the at least one memory, the value that is specific to the user; and
executing, by the assistant, based on the value that is specific to the user, the subsequent command.

20. The computer-readable storage medium of claim 19, wherein the user of the mobile computing device is the user of the home automation device.
